(19) United States
(12) Patent Application Publication
(10) Pub. No.: US 2006/0073236 A1
(43) Pub. Date: Apr. 6, 2006

(54) Method of feeding choline

(75) Inventor: Teun Sleurink, Lahr (DE)

Correspondence Address: PHILIP L BATEMAN, P O BOX 1105, DECATUR, IL, 62525, US

(73) Assignee: Aqtrition USA, LLC, Springfield, IL (US)

(21) Appl. No.: 10/826,627

(22) Filed: Apr. 16, 2004

(51) Int. Cl. A23K 1/18

(52) U.S. Cl. 426/2

(57) ABSTRACT

A non-encapsulated choline compound is fed to a ruminant animal by first dissolving the choline compound in drinking water and then providing the drinking water to the ruminant animal in a sufficient quantity to provide an effective amount of choline to the ruminant animal. Most of the choline compound bypasses the rumen.

### FIELD OF THE INVENTION

This invention relates to supplements for ruminant animals. More particularly, this invention relates to a method of feeding choline that enables it to bypass the rumen.

### BACKGROUND OF THE INVENTION

Ruminant animals are mammals of the suborder Ruminantia that have a stomach divided into four compartments: the rumen, the reticulum, the omasum, and the abomasum. Ingested food remains in the rumen for a period of time while liquids flow through the rumen. For example, recent studies have indicated that about 60 to 70 percent of the drinking water consumed by ruminants passes quickly through the rumen. Bacteria present in the rumen enable ruminants to digest cellulosic materials such as grass. Conventional digestion occurs in the abomasum, sometimes called the “true stomach.” Well-known ruminants include cattle, sheep, and goats.

Choline is a micronutrient that improves milk production in postpartum (lactating) ruminants due to its effect on nerve tissue and fat metabolism: 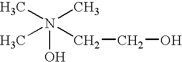
Choline chloride contains a chlorine atom in place of the hydroxyl group attached to the nitrogen atom. Choline chloride has the same biological function as choline. Another choline derivative with a similar biological function is phosphatidyl choline.

Choline is effective in improving milk production in ruminants only if it reaches the abomasum of the animal. Unfortunately, choline is rapidly metabolized by the bacteria present in the rumen. To reduce or eliminate metabolization in the rumen, various techniques have been used to treat the choline so that it bypasses the rumen. One widely used method of protecting choline is to encapsulate it in a solid fat. Blagdon et al., U.S. Pat. No. 5,496,571, issued Mar. 5, 1996, discloses a method of encapsulating choline to produce a rumen bypass supplement for ruminants. This type of encapsulation produces spherical particles having a core of choline surrounded by a shell of fat. The encapsulated choline is then mixed with the solid feed for the ruminant animal. Encapsulation is a relatively expensive manufacturing process. Furthermore, the high degree of saturation of the fat needed for solidification tends to reduce the digestibility of the choline.

It has also been recognized that feeding a rumen-protected choline to prepartum cattle provides benefit. Miller, U.S. Pat. No. 6,106,871, issued Aug. 22, 2000, which is incorporated by reference, discloses a method of increasing milk production in dairy cattle in which rumen-protected choline is fed to prepartum cattle. Miller teaches that the choline is protected by encapsulation in a suitable encapsulating composition. The encapsulated choline is then mixed with the solid feed for the ruminant animal. As previously noted, encapsulation is a relatively expensive manufacturing process.

Accordingly, there is a demand for a method of feeding non-encapsulated choline to a ruminant animal in such a way that the choline bypasses the rumen.

### SUMMARY OF THE INVENTION

The general object of this invention is to provide a method of feeding non-encapsulated choline to a ruminant animal in such a way that the choline bypasses the rumen.

I have invented a method of feeding non-encapsulated choline to a ruminant animal that enables most of the choline to bypass the rumen. The method comprises: (a) dissolving a choline compound in drinking water; (b) providing the choline-containing drinking water to the ruminant animal in a sufficient quantity to provide an effective amount of choline to the ruminant animal.

The method of this invention enables a non-encapsulated choline compound to bypass the rumen of the ruminant animal.

### DETAILED DESCRIPTION OF THE INVENTION

This invention is a two-step method of feeding non-encapsulated choline to a ruminant animal that enables most (more than 50 percent) of the choline to bypass the rumen. The exact percentage that bypasses the rumen depends on several factors, including the concentration of choline in the drinking water, the volume of water consumed, and the rate at which the water is consumed. The percentage that bypasses the rumen is generally greater than 60 percent and is often greater than 70 percent. The first step of the method is to dissolve a choline compound in drinking water. The second step of the method is to provide the choline-containing drinking water to the ruminant animal in a sufficient quantity to provide an effective amount of choline to the ruminant animal.

The choline is non-encapsulated, but otherwise can be in any water-soluble form. Choline compounds such as choline chloride, phosphatidyl choline, choline bitartrate, choline bicarbonate, and choline free base are water soluble and commercially available. The preferred choline compound is choline chloride because of its low cost, high water solubility, and large effective quantity of choline per unit weight of the choline compound.

The choline compound is dissolved in the drinking water that will be provided to the ruminant animal. The desired concentration of the choline compound in the drinking water is calculated after first determining the desired amount of choline compound to be fed to the ruminant animal and estimating the quantity of drinking water the ruminant animal will consume daily. A dairy cow typically drinks about 80 to 120 liters of water per day. The desired amount of choline to be provided to a postpartum (lactating) dairy cow is about 5 to 75 grams per day, preferably about 30 to 50 grams per day. The desired amount to be provided to a prepartum dairy cow in the days before calving is about 5 to 20 grams per day. As an example, if it is desired to provide 40 grams of choline compound per day and if the cow drinks 100 liters of water per day, the choline compound is dissolved in the drinking water at a concentration of 0.4 grams per liter (about 0.04 weight percent), calculated as follows:
40 grams choline=(100 liters drinking water) (0.4 grams choline/1.0 liter drinking water)

The method of this invention surprisingly enables most (more than 50 percent) of the choline compound to pass through the rumen of the ruminant animal without degradation. While not wishing to be bound by theory, it is believed that large quantities of drinking water pass quickly through the rumen. Dissolving the choline compound in the drinking water enables the choline compound to pass quickly through the rumen.

An efficient method of adding a choline compound to the drinking water is to first create a concentrated aqueous solution of the choline compound. This solution is then mixed with the drinking water. It is becoming more common in the dairy industry to add aqueous solutions of minerals and/or vitamins to the drinking water of cattle. Accordingly, it is a relatively simple procedure for the person feeding the cattle to add an additional solution to the drinking water.

I claim:

1. A method of feeding a non-encapsulated choline compound to a ruminant animal that enables most of the choline compound to bypass the rumen, the method comprising:
(a) dissolving a choline compound in drinking water; and
(b) providing the choline-containing drinking water to the ruminant animal in a sufficient quantity to provide an effective amount of choline to the ruminant animal.

2. The method of claim 1 wherein about 5 to 75 g of the choline compound is provided to the ruminant animal daily.

3. The method of claim 2 wherein the choline compound comprises choline chloride.

4. The method of claim 3 wherein the choline-containing drinking water has a choline compound concentration of about 0.005 to 0.1 weight percent.

5. The method of claim 4 wherein the choline-containing drinking water is provided to the ruminant animal in a quantity of about 80 to 120 liters per day.
